(19) United States
(12) Patent Application Publication
(10) Pub. No.: US 2008/0099642 A1
(43) Pub. Date: May 1, 2008

(54) Accessory attachment for handlebar

(76) Inventor: James C. Schoonover, Shelby Township, MI (US)

Correspondence Address: WARN, HOFFMANN, MILLER & LALONE, .P.C, PO BOX 70098, ROCHESTER HILLS, MI, 48307, US

(21) Appl. No.: 11/973,731

(22) Filed: Oct. 10, 2007

Related U.S. Application Data
(60) Provisional application No. 60/851,940, filed on Oct. 16, 2006.

(51) Int. Cl. F16B 2/00

(52) U.S. Cl. 248/230.1

(57) ABSTRACT

The present invention is an accessory attachment, the accessory attachment including a base having an aperture allowing attachment of a clip-on accessory, and an attachment arrangement connected to the base, wherein the attachment arrangement is used to attach the base to a structure.

This application claims the benefit of U.S. Provisional Application No. 60/60/851,940, filed Oct. 16, 2006.

### FIELD OF THE INVENTION

The present invention is an accessory device which is used for stowing various items on the handlebar of a bicycle, motorcycle, or the like.

### BACKGROUND OF THE INVENTION

Handlebars used for bicycles, motorcycles, and other transportation vehicles are well known. It is often common for users of bicycles or motorcycles to carry along various items which are used during travel. These various items are stowed in a number of ways. One way to store various items is to use a typical backpack, or some other type of storage compartment which can be used to store items of various sizes and shapes. These compartments can be carried by the user, such as a backpack, or connected directly to the vehicle. However, sometimes stowing various items in a container such as a backpack limits the accessibility to the item. Accordingly, there exists a need for an improved way to carry items on a bicycle or motorcycle in a stowed position, while allowing greater accessibility to the items.

### SUMMARY OF THE INVENTION

The present invention is an accessory attachment, the accessory attachment including a base having an aperture allowing attachment of a clip-on accessory, and an attachment arrangement connected to the base, wherein the attachment arrangement is used to attach the base to a structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of an accessory attachment, according to the present invention;

FIG. 2 is a side view of an accessory attachment, according to the present invention;

FIG. 3 is a perspective view of an accessory attachment, according to the present invention;

FIG. 4 is a perspective view of an accessory attachment connected to a handlebar, according to the present invention;

FIG. 5 is a first perspective view of an alternate embodiment of an accessory attachment, according to the present invention;

FIG. 6 is a second perspective view of an alternate embodiment of an accessory attachment, according to the present invention; and

FIG. 7 is a side view of an alternate embodiment of an accessory attachment, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

Referring generally to the figures, an accessory attachment for a handlebar is generally shown at 10. The attachment 10 has a base 12 along with an attachment arrangement used for connecting the base 12 to a structure. In this embodiment, the attachment arrangement are two curved portions, a first curved portion 14 and a second curved portion 16 extending away from the base 12. The first curved portion 14 has a first camming flange 18, and the second curved portion 16 has a second camming flange 20. The first curved portion 14 and the second curved portion 16 form a space 22 which is used for receiving a structure such as a substantially cylindrical member, which in this embodiment is a handlebar of a typical bicycle or motorcycle, the function of which will be described later. The base 12 also includes an aperture 24, which extends through the entire base 12. In a preferred embodiment, aperture 24 has a square cross-sectional shape which is of a size to accept conventional belt-clip type accessories such as cell phones, pagers, or the like.

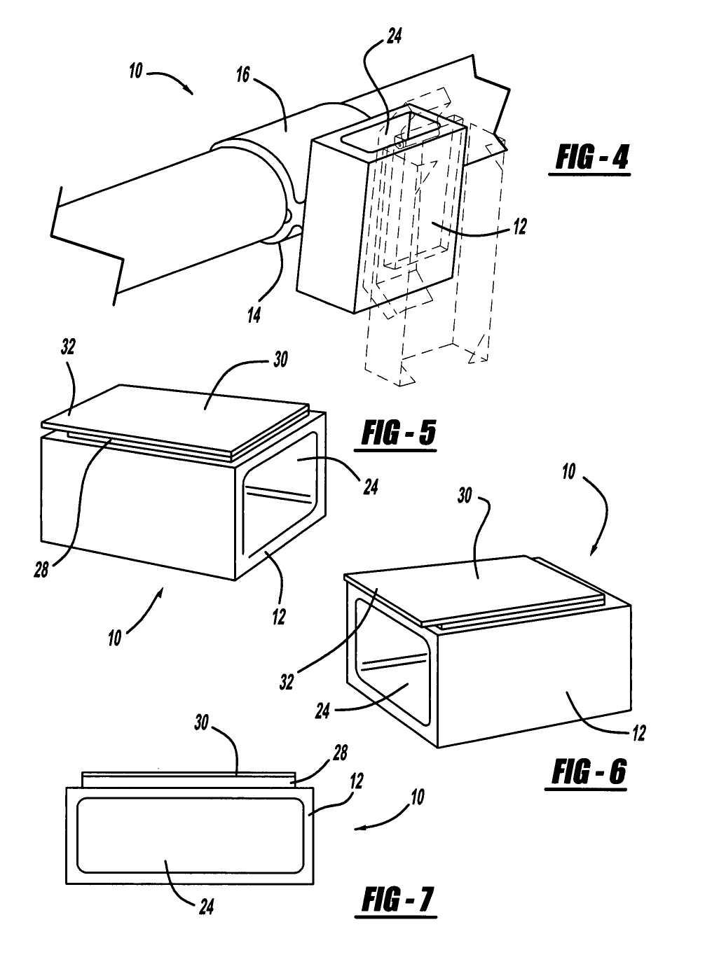

An accessory attachment 10 attached to a handlebar 26 of a typical bicycle or motorcycle is shown in FIG. 4. When in use, the first camming flange 18 and the second camming flange 20 initially receive the handlebar 26 and force the first and second curved portions 14, 16 apart. Once enough force is applied to the base 12, the first curved portion 14 and the second curved portion 16 will expand in a manner such that the first camming flange 18 and the second camming flange 20 move away from each other. The first curved portion 14 and the second curved portion 16 will remain connected to the base 12. In order for the first curved portion 14 and the second curved portion 16 to remain connected to the base 12, while still having the ability to flex in a manner so as to allow the first camming flange 18 and the second camming flange 20 to expand away from each other, the first curved portion 14 and the second curved portion 16 are made of a material which will allow the first curved portion 14 and the second curved portion 16 to flex, but which is structurally sound enough to hold the attachment 10 on the handlebar 26 securely and also support the attached accessory. Suitable materials include moldable polymers or extrudable polymers such as polyethylene or nylon. In a preferred embodiment, the attachments are injection molded or extruded.

Once enough force is applied to the base 12, the first and second curved portions 14, 16 will expand enough to allow the handlebar 26 to be received into the space 22. Once inserted into the space 22, the first and second curved portions 14, 16 will apply a force to the handlebar 26 such that the attachment 10 will be held in place.

Once the attachment 10 is held in place, the aperture 24 in the base 12 is then used for receiving various clip-on accessories or clip devices (best shown in FIG. 4) which are typically used for stowing a device such as a cell phone, pager, palm pilots, or the like.

Once it is desired to remove the attachment 10 from the handlebar, the attachment 10 is simply pulled away from the handlebar 26 in such a manner that the force applied to the handlebar 26 by the first and second curved portions 14, 16 is overcome, allowing the attachment 10 to be separated from the handlebar.

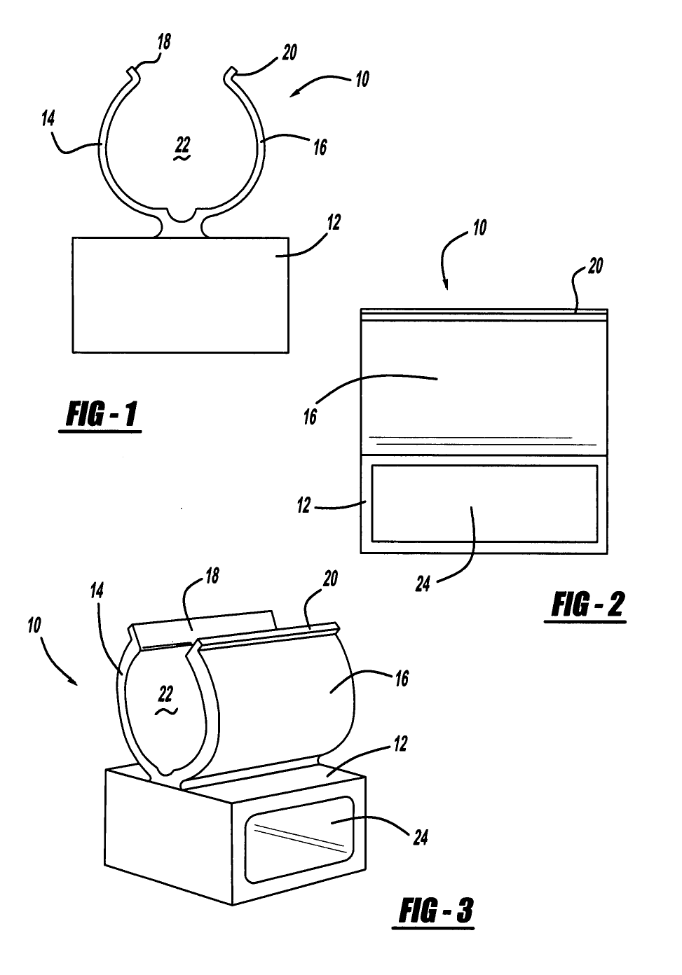

In the embodiment shown in FIGS. 1-4, the first and second curved portions 14, 16 are shown as being integrally formed with the base 12. However, it is within the scope of the invention that the first and second curved portions 14, 16 could be formed as a single component separate from the base, and attached to the base 12 through the use of a typical fastener, such as a screw, or double sided tape. Additionally, the base 12 could be attached to a wall or other object without the use of the first and second curved portions 14, 16, by using a different type of attachment arrangement such as a screw, double sided tape, or other fastener. This allows the base 12 to be used to hold various objects without the use of the first and second curved portions 14, 16.

An alternate embodiment of the accessory attachment 10 without the first and second curved portions 14, 16 is shown in FIGS. 5-7. The attachment 10 still includes the base 12 having the aperture 24, the attachment arrangement in this embodiment a layer of double sided tape 28, and a removable layer 30. The removable layer 30 is a non-stick layer which is peeled away from the double sided tape 28 when the attachment 10 is to be attached to a structure such as a wall, door, etc. The removable layer 30 also includes an overhang or tab 32, which is used for peeling away the removable layer 30. Once the removable layer 30 is removed, the attachment 10 can be attached to almost any surface, and the attachment 10 can be used to hold various objects as set forth above.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An accessory attachment, comprising:
a base having an aperture allowing attachment of a clip-on accessory; and
an attachment arrangement connected to said base, wherein said attachment arrangement is used to attach said base to a structure.

2. The accessory attachment of claim 1, said attachment arrangement further comprising:
a first curved portion having a first camming flange, said first curved portion connected to said base;
a second curved portion having a second camming flange, said second curved portion connected to said base in proximity to said first curved portion;
a space formed by said first curved portion and said second curved portion; and
said structure further comprises a substantially cylindrical member, wherein said first camming flange and said second camming flange are operably associated with said substantially cylindrical member such that when said first camming flange and said second camming flange receive said substantially cylindrical member and a force is applied to said base, said substantially cylindrical member will be positioned in said space, and said first curved portion and said second curved portion will surround said substantially cylindrical member, thereby holding said base, said first curved portion, and said second curved portion in place.

3. The accessory attachment of claim 1, said structure further comprising a wall or a substantially cylindrical member.

4. The accessory attachment of claim 3, wherein said substantially cylindrical member is a handlebar.

5. The accessory attachment of claim 1, said attachment arrangement further comprising a layer of double-sided tape, wherein said layer double-sided tape is used for attaching said base to said structure.

6. The accessory attachment of claim 1, wherein said aperture of said base receives a clip.

7. An accessory attachment which is selectively attached to a structure, comprising:
a base having an aperture;
a first curved portion connected to said base; and
a second curved portion connected to said base, said first curved portion operably associated with said second curved portion such that said first curved portion and said second curved portion selectively connect said base to a structure.

8. The accessory attachment which is selectively attached to a structure of claim 7, further comprising:
a first camming flange connected to said first curved portion;
a second camming flange connected to said second curved portion; and
said structure is a substantially cylindrical member, wherein as said first curved portion and said second curved portion are attached to said substantially cylindrical member, said first camming flange and said second camming flange will initially contact said substantially cylindrical member.

9. The accessory attachment which is selectively attached to a structure of claim 7, wherein said first curved portion and said second curved portion are connected to said base through the use of a fastener, said fastener selected from the group consisting of a screw, a weld, glue, and double-sided tape.

10. The accessory attachment which is selectively attached to a structure of claim 7, wherein said structure is a substantially cylindrical member, and as said first curved portion and said second curved portion are attached to said substantially cylindrical member, said first curved portion and said second curved portion flex to receive and surround at least a portion of said substantially cylindrical member, and when said first curved portion and said second curved portion surround at least a portion of said substantially cylindrical member, said first curved portion and said second curved portion will apply a force to said substantially cylindrical member.

11. The accessory attachment which is selectively attached to a structure of claim 10, wherein said substantially cylindrical member is one selected from the group consisting of a handlebar for a bicycle and a handlebar for a motorcycle.

12. An accessory attachment which is attached to a structure, comprising:
a base having an aperture;
at least one adhesive layer connected to said base, wherein said at least one adhesive layer connects said base to a structure.

13. The accessory attachment which is attached to a structure of claim 12, further comprising a removable layer selectively attached to said adhesive layer, wherein said removable layer has no adhesive properties and prevents said adhesive layer from attaching said base to said structure, and said removable layer is removed from said adhesive layer when said base is connected to said structure.

14. The accessory attachment which is attached to a structure of claim 13, wherein a portion of said removable layer overhangs from said adhesive layer, and said portion of said removable layer which overhangs from said adhesive layer is pulled to remove said removable layer from said adhesive layer.

15. The accessory attachment which is attached to a structure of claim 12, said structure further comprising a wall.

16. A method for attaching an accessory to a structure using an accessory attachment, comprising the steps of:
providing an accessory attachment which includes a base having an aperture, a first curved portion and a second curved portion, both of said first curved portion and said second curved portion connected to said base;
providing a vehicle having a bar portion with a circular cross-section;
providing an accessory having a clip-member;
selectively attaching said accessory attachment to said bar portion of said vehicle; and
selectively attaching said accessory to said accessory attachment using said aperture of said base.

17. The method for attaching an accessory to a structure using an accessory attachment of claim 16, further comprising the steps of:
forming a space with said first curved portion and said second curved portion;
providing a first camming flange formed as a portion of said first curved portion;
providing a second camming flange formed as a portion of said second curved portion; and
receiving said bar portion with said first camming flange and said second camming flange.

18. The method for attaching an accessory to a structure using an accessory attachment of claim 17, further comprising the steps of:
applying a force to said base after said bar portion is received by said first camming flange and said second camming flange such that said first curved portion and said second curved portion at least partially deflect;
positioning said bar portion in said space between said first curved portion and said second curved portion by applying force to said base after said first curved portion and said second curved portion partially deflect; and
applying a force to said bar portion with said first curved portion and said second curved portion after said bar portion is positioned in said space by partially deflecting said first curved portion and said second curved portion.

19. The method for attaching an accessory to a structure using an accessory attachment of claim 16, further comprising the steps of:
providing a fastener; and
attaching said first curved portion and said second curved portion to said base.

20. The method for attaching an accessory to a structure using an accessory attachment of claim 16, further comprising the steps of:
selecting said fastener from the group consisting of a screw, a weld, glue, and double-sided tape.

21. The method for attaching an accessory to a structure using an accessory attachment of claim 16, further comprising the steps of forming said first curved portion and said second curved portion integrally with said base.
